(19) United States
(12) Patent Application Publication
(10) Pub. No.: US 2015/0110932 A1
(43) Pub. Date: Apr. 23, 2015

(54) Methods and Systems for Inactivation of Bacteria in Liquid Using Liquid-Phase Electrical Discharge Plasmas

(71) Applicants: Selma Mededovic Thagard, Potsdam, NY (US); Shane Rogers, Potsdam, NY (US)

(72) Inventors: Selma Mededovic Thagard, Potsdam, NY (US); Shane Rogers, Potsdam, NY (US)

(73) Assignee: CLARKSON UNIVERSITY, Potsdam, NY (US)

(21) Appl. No.: 14/517,533

(22) Filed: Oct. 17, 2014

Related U.S. Application Data
(60) Provisional application No. 61/892,800, filed on Oct. 18, 2013.

(51) Int. Cl. A23L 3/32; A23L 3/28

(52) U.S. Cl. CPC A23L 3/32; A23L 3/28
USPC 426/235; 426/237; 426/248; 99/451

(57) ABSTRACT

An electrical discharge plasma reactor system for inactivating one or more pathogens in a liquid. The reactor system includes a reactor chamber configured to hold the liquid, a silver discharge electrode and a non-discharge electrode disposed within the reactor chamber such that the two electrodes are in spaced, conductive communication when the liquid is inside the reactor chamber, and a power supply connected to at least one of the discharge and non-discharge electrodes and configured to induce the discharge electrode to generate plasma to at least partially inactivate one or more pathogens in the liquid.

### CROSS-REFERENCE TO RELATED APPLICATIONS

This application claims priority to U.S. Provisional Patent Application Ser. No. 61/892,800, filed on Oct. 18, 2013, the entire disclosure of which is incorporated herein by reference.

### BACKGROUND

The present invention relates to methods and systems for food preservation using non-thermal sterilization processes, and, more particularly, to methods and systems of microbial inactivation in liquids using liquid-phase electrical discharge plasma.

Food preservation requires inactivation of the pathogenic microorganisms that cause spoilage and other undesirable reactions in the food. Traditionally, the sterilization of food products was carried out using heating, which is energy intensive and often harms the quality of the food. In contrast, non-thermal food preservation methods such as gamma irradiation, hydrostatic pressure, and pulsed electric fields tend to preserve the color, flavor, and nutrients of the food while inactivating spoilage microorganisms, pathogens, and enzymes. However, the high level of resistance of certain enzymes and microorganisms, especially bacterial spores, to non-thermal processing limits the application of these methods.

Liquid-phase electrical discharge plasmas have been shown to inactivate microorganisms without significant increase in temperature during the treatment, which makes it a viable alternative to the conventional thermal food preservation process. An electrical discharge between two metal electrodes immersed in or placed above a liquid generates a plasma and results in the formation of active radicals, shockwaves, and the emission of UV light. Electrical discharges directly in water have been shown to destroy bacteria, yeasts, and viruses. Pulsed discharges with energies in the range of Joule per pulse have been shown to inactivate E. coli, S. aureus, S. enterititus, M. aeruginosa, bacilli, P. putida, and food pathogens, among others. Bacteria have also been inactivated by higher kiloJoule per pulse discharges using different high voltage electrode materials. However, liquid-phase electrical discharge plasma can be both inefficient and expensive.

Accordingly, there is a need in the art for more effective and affordable methods and systems of microbial inactivation in liquids using liquid-phase electrical discharge plasma.

### BRIEF SUMMARY

The present disclosure is directed to inventive methods and apparatus for microbial inactivation in liquids using liquid-phase electrical discharge plasma. Various embodiments and implementations herein are directed to an apparatus and method in which electrical discharges are created at the tip of a high-voltage silver electrode resulting in the formation of a plasma and the subsequent microbial inactivation.

According to one aspect is an electrical discharge plasma reactor system for inactivating one or more pathogens in a liquid, the reactor system including a reactor chamber configured to hold the liquid; a silver discharge electrode disposed within the reactor chamber; a non-discharge electrode disposed within the reactor chamber, the discharge and non-discharge electrodes being in spaced, conductive communication when the liquid is inside the reactor chamber; and a power supply connected to at least one of the discharge and non-discharge electrodes, the power supply configured to induce the discharge electrode to generate plasma to at least partially inactivate one or more pathogens in the liquid.

According to an embodiment, the discharge electrode is configured to be disposed within the liquid when the liquid is inside the reactor chamber. According to another embodiment, the discharge electrode is configured to not be disposed within the liquid when the liquid is inside the reactor chamber.

According to an embodiment, the non-discharge electrode is configured to be disposed within the liquid when the liquid is inside the reactor chamber. According to another embodiment, the non-discharge electrode is configured to not be disposed within the liquid when the liquid is inside the reactor chamber.

According to an embodiment, the liquid is a human consumable liquid.

According to an embodiment, the reactor chamber includes a gas input, and the system further includes an external gas source configured to provide gas to the reactor chamber during operation.

According to an embodiment, the system also a filter for the liquid and/or a UV light source.

According to one aspect is a method for inactivating one or more pathogens in a liquid, the method including the steps of: providing an electrical discharge plasma reactor system, the system comprising: (i) a reactor chamber configured to hold the liquid; (ii) a silver discharge electrode disposed within the reactor chamber; (iii) a non-discharge electrode disposed within the reactor chamber, the discharge and non-discharge electrodes being in spaced, conductive communication when the liquid is inside the reactor chamber; and (iv) a power supply connected to at least one of the discharge and non-discharge electrodes, the power supply configured to induce the discharge electrode to generate plasma to at least partially inactivate one or more pathogens in the liquid; adding the liquid to the reactor chamber; and inducing the discharge electrode to generate plasma.

According to an embodiment, the method includes the step of injecting an external gas to the reactor chamber during said inducting step.

According to an embodiment, the method includes the step of injecting a liquid to the reactor chamber during said inducting step.

According to an embodiment, the method includes the step of filtering the liquid.

According to an embodiment, the method includes the step of incubating the liquid in UV light.

According to an embodiment, the discharge electrode is configured to be disposed within the liquid when the liquid is inside the reactor chamber.

According to an embodiment, the discharge electrode is configured to not be disposed within the liquid when the liquid is inside the reactor chamber.

According to an embodiment, the non-discharge electrode is configured to be disposed within the liquid when the liquid is inside the reactor chamber.

According to an embodiment, the non-discharge electrode is configured to not be disposed within the liquid when the liquid is inside the reactor chamber.

According to an embodiment, the liquid is a human consumable liquid.

According to an aspect is an electrical discharge plasma reactor configured to inactivate one or more pathogens in a liquid, the reactor including: (i) a chamber configured to hold the liquid; (ii) a silver discharge electrode disposed within the chamber; (iii) a non-discharge electrode disposed within the chamber, the discharge and non-discharge electrodes being in spaced, conductive communication when the liquid is inside the reactor chamber; and (iv) a power supply connected to at least one of the discharge and non-discharge electrodes, the power supply configured to induce the discharge electrode to generate plasma to at least partially inactivate one or more pathogens in the liquid.

These and other aspects of the invention will be apparent from the embodiment(s) described hereinafter.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic representation of a system for microbial inactivation of a liquid in accordance with an embodiment.

FIG. 2 is a schematic representation of a system for microbial inactivation of a liquid in accordance with an embodiment.

FIG. 3 is a schematic representation of a system for microbial inactivation of a liquid in accordance with an embodiment.

FIG. 4 is a schematic representation of a system for microbial inactivation of a liquid in accordance with an embodiment.

FIG. 5 is a flow chart of a method for microbial inactivation of a liquid in accordance with an embodiment.

### DETAILED DESCRIPTION

The present disclosure describes methods and systems for microbial inactivation, providing a solution to a long-felt need for more effective and affordable methods and systems of microbial inactivation in liquids. Sterilization effects of liquid-phase plasmas have been attributed to combinations of chemical, physical, and electrical effects. Previous electrical discharge plasma studies, however, failed to consider or use silver as a high-voltage electrode material to sterilize liquids. Further, these previous attempts failed to use or consider streamer-like (i.e., plasma is not bridging the gap between the electrodes) or spark (i.e., plasma is bridging the gap) electrical discharge directly in the liquid. Accordingly, various embodiments and implementations are directed to an apparatus and method in which electrical discharges are created at the tip of a high-voltage silver electrode resulting in the formation of a plasma and the subsequent microbial inactivation.

Using silver as the discharge electrode greatly increases the efficiency of the microbial inactivation. Compared to other electrodes, the use of silver unexpectedly decreases the treatment time required for complete inactivation. Significant inactivation takes place at high (>100 Hz) discharge frequencies. The system is preferably operated at low liquid temperatures such as the range between refrigeration to room temperature. Compared to pasteurization, the process described herein requires two orders of magnitude lower energy, thereby resulting in significant cost and efficiency savings.

According to an embodiment, streamer-like and spark electric discharges are generated by a high-voltage pulsed power supply where voltages can range from approximately 10,000 to 100,000 V. According to an embodiment, the discharge electrodes can be exclusively composed of silver, including but not limited to plate, tube, wire, and/or foam. According to an embodiment, non-discharge electrodes can be plate, tube, and/or foam and can be composed of silver, stainless steel, and carbon.

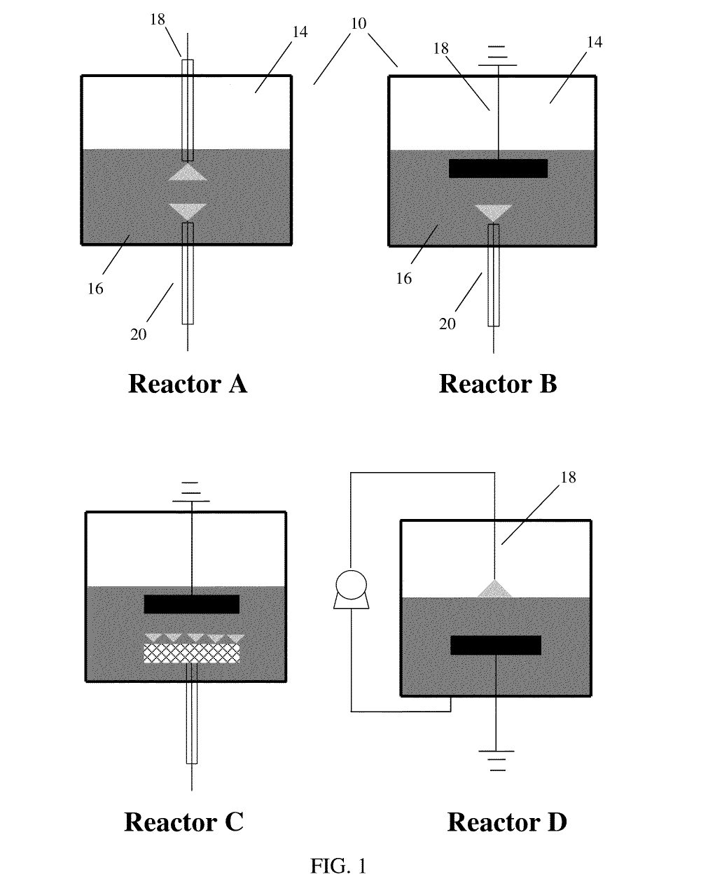

Referring now to the drawings, wherein like reference numerals refer to like parts throughout, there is seen in FIG. 1, in one embodiment, an electrical discharge plasma reactor configuration for microbial inactivation in liquids using silver as a high-voltage electrode material. According to this embodiment, the microbial inactivation system or reactor 10 includes a chamber 14. Chamber 14 can be very small or very large, as long as there is sufficient voltage, and thus sufficient plasma, to sterilize the liquid within the chamber. Chamber 14 can include liquid 16 to be sterilized. The liquid can be any liquid for which sterilization is desired, including but not limited to a liquid being or containing water, milk, juice, or any other consumable liquid. Liquid 16 can also be a liquid or semi-liquid food.

Chamber 14 also comprises a first electrode 18 and a second electrode 20. According to an embodiment, the discharge electrodes can be exclusively composed of silver, including but not limited to plate, tube, wire, and/or foam. According to an embodiment, non-discharge electrodes can be plate, tube, and/or foam and can be composed of silver, stainless steel, and carbon, among others. The configuration of electrodes in Reactor A in FIG. 1 can be, for example, needle-to-needle or point-to-point, where one of electrodes 18 and 20 is the anode and the other is the cathode. During operation, a high-voltage power supply can supply voltages ranging from approximately 10,000 to 100,000 V, for example, although other voltages are possible. Reactors I and J have a similar configuration to Reactor A in FIG. 1.

According to various embodiments, the discharge electrode can be placed in the liquid or the gas of chamber 14, the non-discharge electrode can be placed either in the liquid or the gas of chamber 14.

Reactor B in FIG. 1, according to an embodiment, includes a chamber 14 with liquid 16 and two electrodes, a needle or point electrode 20 and a plate electrode 18. Reactors G, and H have a similar configuration to Reactor B in FIG. 1. Reactor C is also similar in configuration to Reactor B in FIG. 1, although Reactor C utilizes a foam plane electrode 20.

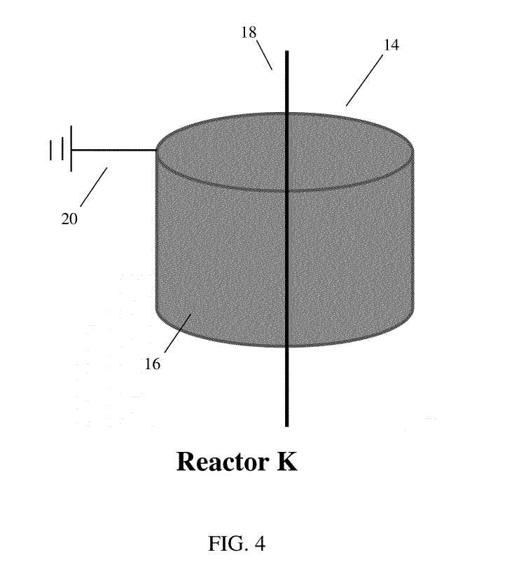

Reactor K in FIG. 4, according to an embodiment, includes an approximately cylindrical chamber 14 with liquid 16, and two electrodes, an approximately cylindrical ground electrode 20 and a wire electrode 18.

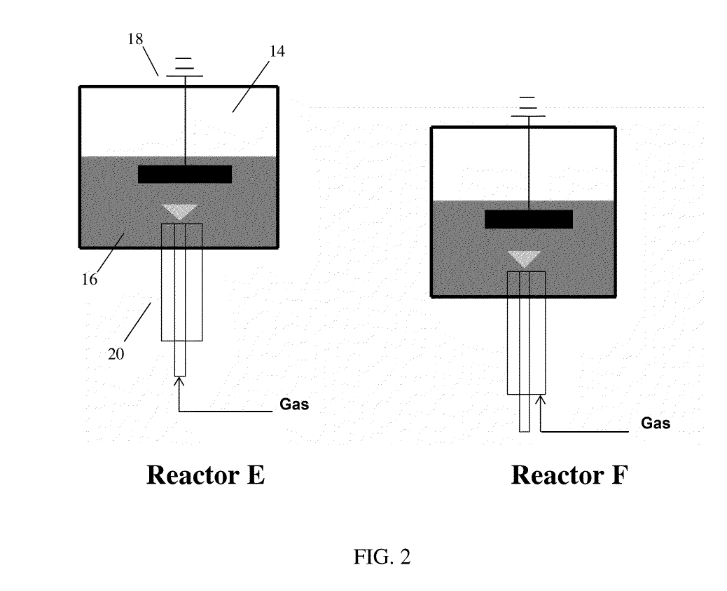

According to various embodiments, the discharge electrode can operate in the presence of an external gas, and/or liquid can be sprayed through the discharge electrode to further optimize inactivation of microbes and pathogens. For example, Reactor D in FIG. 1, according to an embodiment, includes a chamber 14 with liquid 16 and two electrodes, a needle or point electrode 20 and a plate electrode 18. Unlike previous configurations, Reactor D also provides a liquid feed around or through the high voltage electrode 18. As another example, Reactors E and F in FIG. 2, according to an embodiment, includes a chamber 14 with liquid 16 and two electrodes, an electrode 20 and a plate electrode 18. Unlike previous configurations, Reactors E and F provide a gas feed around or through the high voltage electrode 20.

Although reactors A-K shown in FIGS. 1-4 are shown with only two electrodes each, they can comprise multiple electrodes. For example, there can be a mesh electrode, an electrode with multiple points or needles, and a variety of other types of electrodes to optimize the flow of energy and to direct the optimized creation of plasma.

TABLE 1 is a summary of various embodiments of the electrical discharge reactors according to the invention, including but not limited to the embodiments described in FIGS. 1-6 (reactors A-K). In all these reactors, the operation can be either batch or continuous.

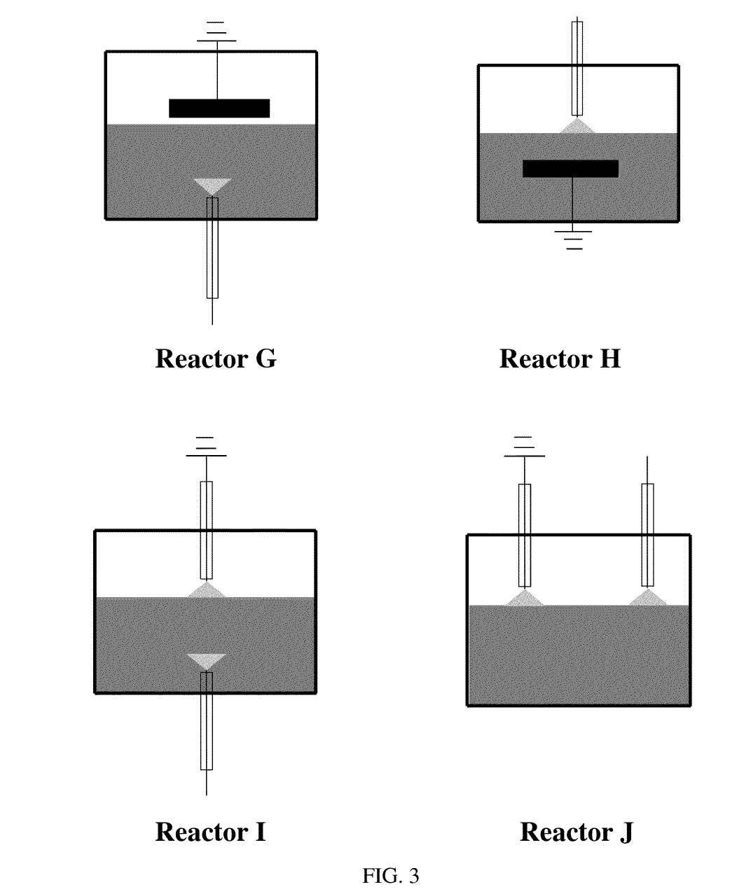

TABLE 1
Description of the electrical discharge reactors

| | High | | High | | |
|---|---|---|---|---|---|
| Electrode | voltage | Ground | voltage | Ground | |
| configuration | (HV) type | type | phase | phase | Notes |
| A (FIG. 1) | point | point | liquid | liquid | — |
| B (FIG. 1) | point | plane | liquid | liquid | — |
| C (FIG. 1) | foam | plane | liquid | liquid | — |
| | plane | | | | |
| D (FIG. 1) | point | plane | gas | liquid | liquid feed |
| | | | | | around or |
| | | | | | through HV |
| E (FIG. 2) | point | plane | liquid | liquid | gas feed through |
| | | | | | HV |
| F (FIG. 2) | point | plane | liquid | liquid | gas feed around |
| | | | | | HV |
| G (FIG. 3) | point | plane | liquid | gas | — |
| H (FIG. 3) | point | plane | gas | liquid | — |
| I (FIG. 3) | point | point | gas | liquid | — |
| J (FIG. 3) | point | point | gas | gas | — |
| K (FIG. 4) | wire | cylinder | liquid | gas | — |

The inactivation system 10 is versatile, and can for example be combined, for example, with filtration and UV light inactivation, among a variety of other mechanisms for inactivation. The systems described herein are effective at a wide variety of temperatures (including very low temperatures) and pressures, and can be scaled-up to industrial levels. The systems are effective for a wide range of electrical conductivities, and yet the energy consumption of the process is at least two orders of magnitude lower than that of the existing thermal processes. The reactor can, for example, be made of glass or any other food-grade material, and the systems described herein are effective with or without chemical, physical and biological additives.

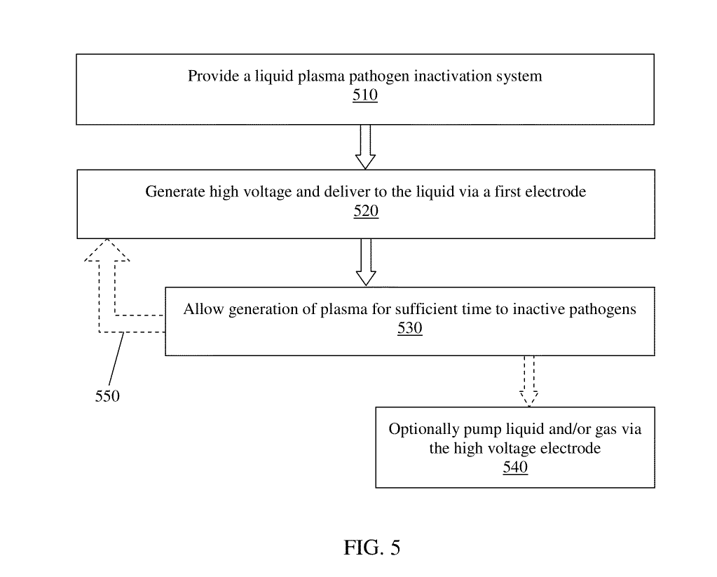

Referring to FIG. 5, a flow chart illustrating a method 500 for method for microbial inactivation in which electrical discharges are created at the tip of a high-voltage silver electrode resulting in the formation of a plasma in accordance with an embodiment of the invention is disclosed. In step 510, an electrical discharge plasma reactor system 10 for pathogen inactivation in liquids using silver as a high-voltage electrode material is provided. Pathogen inactivation system or reactor 10 may be may be any of the embodiments described herein or otherwise envisioned, and can include any of the reactors and/or systems described in conjunction with FIGS. 1-4. For example, pathogen inactivation system or reactor 10 can include a chamber 14 with liquid 16, a first electrode 18, and a second electrode 20. One or both of first electrode 18 and/or second electrode 20 are composed of silver, including but not limited to plate, tube, wire, and/or foam. According to an embodiment, one of the electrodes can be plate, tube, and/or foam and can be composed of silver, stainless steel, and carbon, among others.

In step 520, high voltage is generated and delivered to the liquid via a high energy electrode such as first electrode 18 or second electrode 20. During operation, a high-voltage power supply can supply voltages ranging from approximately 10,000 to 100,000 V, for example, although other voltages are possible. In step 530, the voltage is applied and plasma is generated for a sufficient amount of time to allow for the inactivation of pathogens in the liquid. This amount of time is shorter than normal due to the higher efficiency of the silver electrode(s), and can vary depending upon the liquid, the concentration of pathogens, feedback information, sensor information, temperature and pressure, and a variety of other factors.

In optional step 540, the liquid 16 can, for example, be pumped from the chamber 14 and pumped back in through or around an electrode, such as depicted in Reactor D. Alternatively, the system can pump a gas into the chamber 14 through or around an electrode, such as depicted in Reactors E and F.

In optional step 550, one or more steps of the process can be repeated. Experimentation or theoretical analysis can determine that repeated cycles of plasma generation are needed for the most effective inactivation of pathogens in a particular liquid, or for the inactivation of particularly resistant pathogens.

Although the present invention has been described in connection with a preferred embodiment, it should be understood that modifications, alterations, and additions can be made to the invention without departing from the scope of the invention as defined by the claims.

What is claimed is:

1. An electrical discharge plasma reactor system for inactivating one or more pathogens in a liquid, the reactor system comprising:
a reactor chamber configured to hold the liquid;
a silver discharge electrode disposed within the reactor chamber;
a non-discharge electrode disposed within the reactor chamber, the discharge and non-discharge electrodes being in spaced, conductive communication when the liquid is inside the reactor chamber; and
a power supply connected to at least one of the discharge and non-discharge electrodes, the power supply configured to induce the discharge electrode to generate plasma to at least partially inactivate one or more pathogens in the liquid.

2. The system of claim 1, wherein the discharge electrode is configured to be disposed within the liquid when the liquid is inside the reactor chamber.

3. The system of claim 1, wherein the discharge electrode is configured to not be disposed within the liquid when the liquid is inside the reactor chamber.

4. The system of claim 1, wherein the non-discharge electrode is configured to be disposed within the liquid when the liquid is inside the reactor chamber.

5. The system of claim 1, wherein the non-discharge electrode is configured to not be disposed within the liquid when the liquid is inside the reactor chamber.

6. The system of claim 1, wherein the liquid is a human consumable liquid.

7. The system of claim 1, wherein the reactor chamber comprises a gas input, and wherein the system further comprises an external gas source configured to provide gas to the reactor chamber during operation.

8. The system of claim 1, further comprising a filter for the liquid.

9. The system of claim 1, further comprising a UV light source.

10. A method for inactivating one or more pathogens in a liquid, the method comprising the steps of:
providing an electrical discharge plasma reactor system, the system comprising: (i) a reactor chamber configured to hold the liquid; (ii) a silver discharge electrode disposed within the reactor chamber; (iii) a non-discharge electrode disposed within the reactor chamber, the discharge and non-discharge electrodes being in spaced, conductive communication when the liquid is inside the reactor chamber; and (iv) a power supply connected to at least one of the discharge and non-discharge electrodes, the power supply configured to induce the discharge electrode to generate plasma to at least partially inactivate one or more pathogens in the liquid;
adding the liquid to the reactor chamber; and
inducing the discharge electrode to generate plasma.

11. The method of claim 10, further comprising the step of injecting an external gas to the reactor chamber during said inducting step.

12. The method of claim 10, further comprising the step of injecting a liquid to the reactor chamber during said inducting step.

13. The method of claim 10, further comprising the step of filtering the liquid.

14. The method of claim 10, further comprising the step of incubating the liquid in UV light.

15. The method of claim 10, wherein the discharge electrode is configured to be disposed within the liquid when the liquid is inside the reactor chamber.

16. The method of claim 10, wherein the discharge electrode is configured to not be disposed within the liquid when the liquid is inside the reactor chamber.

17. The method of claim 10, wherein the non-discharge electrode is configured to be disposed within the liquid when the liquid is inside the reactor chamber.

18. The method of claim 10, wherein the non-discharge electrode is configured to not be disposed within the liquid when the liquid is inside the reactor chamber.

19. The method of claim 10, wherein the liquid is a human consumable liquid.

20. An electrical discharge plasma reactor configured to inactivate one or more pathogens in a liquid, the reactor comprising:
a chamber configured to hold the liquid;
a silver discharge electrode disposed within the chamber;
a non-discharge electrode disposed within the chamber, the discharge and non-discharge electrodes being in spaced, conductive communication when the liquid is inside the reactor chamber; and
a power supply connected to at least one of the discharge and non-discharge electrodes, the power supply configured to induce the discharge electrode to generate plasma to at least partially inactivate one or more pathogens in the liquid.
